(19) United States
(12) Patent Application Publication
(10) Pub. No.: US 2008/0179850 A1
(43) Pub. Date: Jul. 31, 2008

(54) DEVICE FOR GUIDING A CHILD'S FIRST STEPS

(75) Inventor: Francesco CATELLI, Como (IT)

Correspondence Address: OBLON, SPIVAK, MCCLELLAND MAIER & NEUSTADT, P.C., 1940 DUKE STREET, ALEXANDRIA, VA, 22314, US

(73) Assignee: ARTSANA S.p.A., Grandate (Como) (IT)

(21) Appl. No.: 12/022,569

(22) Filed: Jan. 30, 2008

(30) Foreign Application Priority Data
Jan. 31, 2007 (IT) MI2007 U 000029

(51) Int. Cl. B62B 7/00; A61H 3/00

(52) U.S. Cl. 280/87.051; 135/67

(57) ABSTRACT

A device (1) for guiding a child's first steps, comprising a body (11) mounted on wheels (5, 6) and provided with an upper part (7) having a handgrip or handle (12) which the child grips to support itself during the first steps. The handle (12) can assume a plurality of stable positions corresponding to different handle heights from a surface (P) on which the wheels (5, 6) rest, hence enabling the child to grip the handle (12) with the correct posture at different stages of its growth.

The present invention relates to device for guiding a child's first steps in accordance with the introduction to the main claim.

Various devices are known for guiding a child in learning to walk. The most well known are baby walkers, i.e. devices comprising an annular body with a wheel-mounted seat, within which the child is placed; by suitably adjusting the height of the seat from a surface on which the baby walker rests and moves, the child is able to move by resting its feed on this surface. Other devices enable a child to learn to walk by a thrust which is generated on a wheel-mounted body.

An object of the present invention is to provide a device enabling a child to learn to walk while maintaining an ergonomically correct position or posture.

Another object is to provide a device of the stated type which can be used by the same child in an anatomically correct manner, during various stages of its growth.

A further object is to provide a device of the stated type which is simple to use.

A further object is to provide a device of the stated type which is simple to produce and transport.

These and further objects which will be apparent to the expert of the art are attained by a device in accordance with the accompanying claims.

The present invention will be more apparent from the accompanying drawings, which are provided by way of non-limiting example and in which:

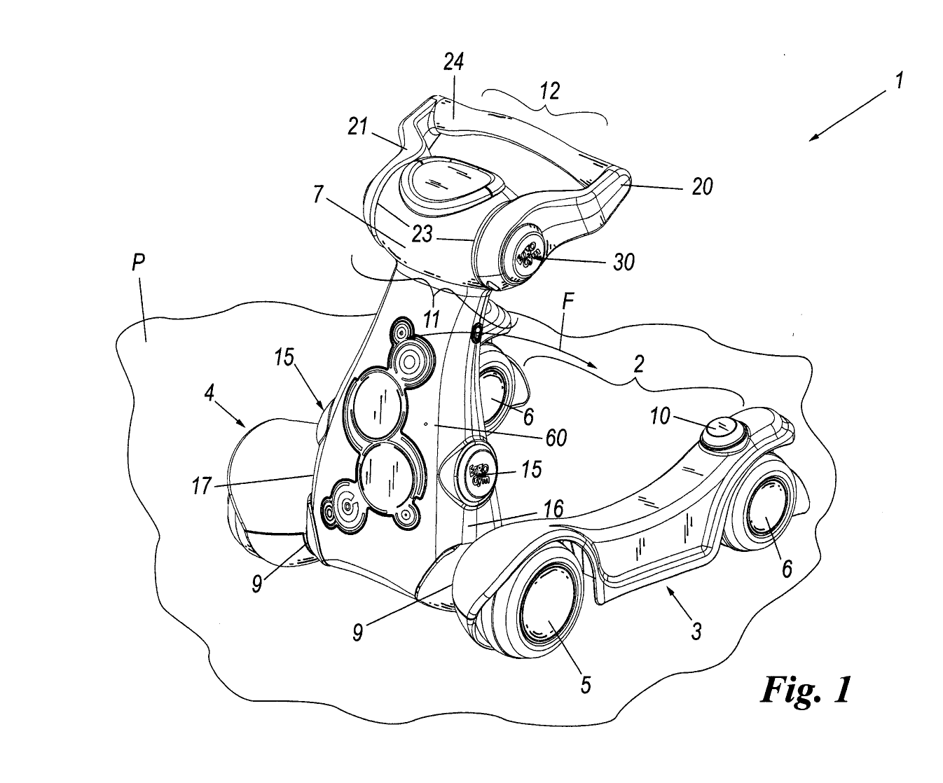

FIG. 1 is a perspective view of a device of the invention;

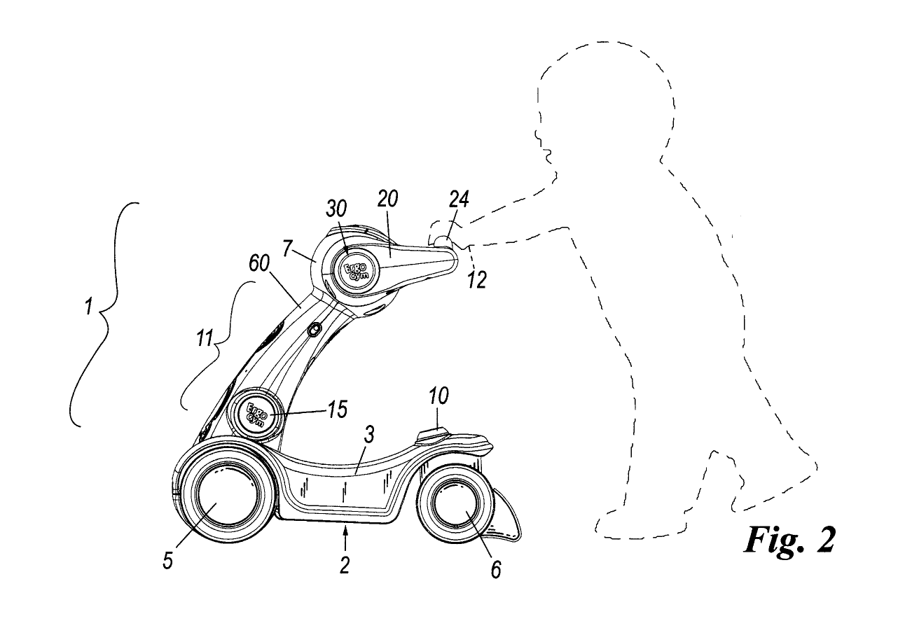

FIG. 2 is a side view of the device of FIG. 1;

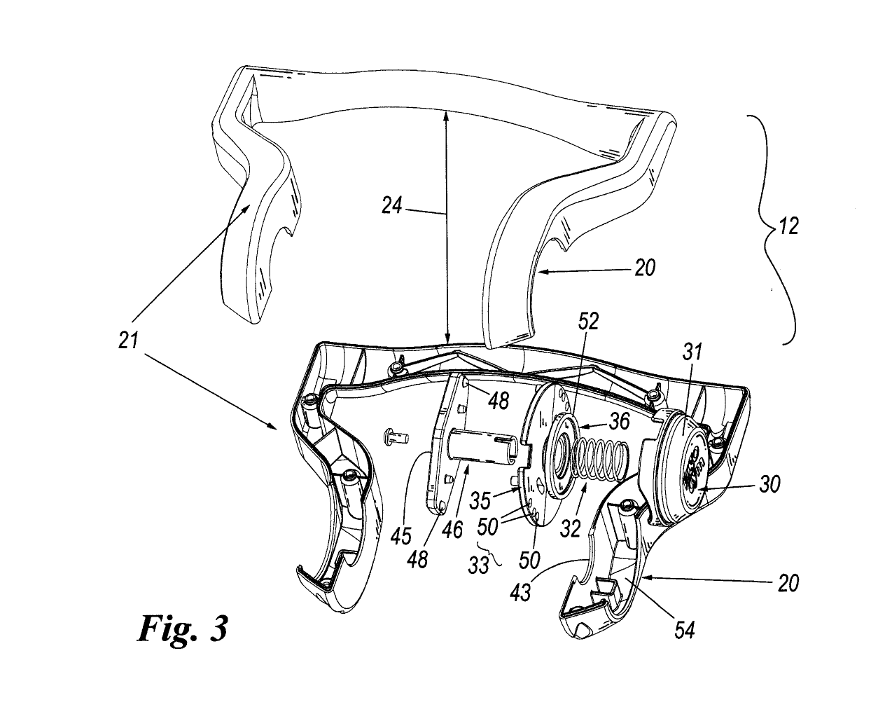

FIG. 3 is an exploded perspective view of a part of the device of FIG. 1;

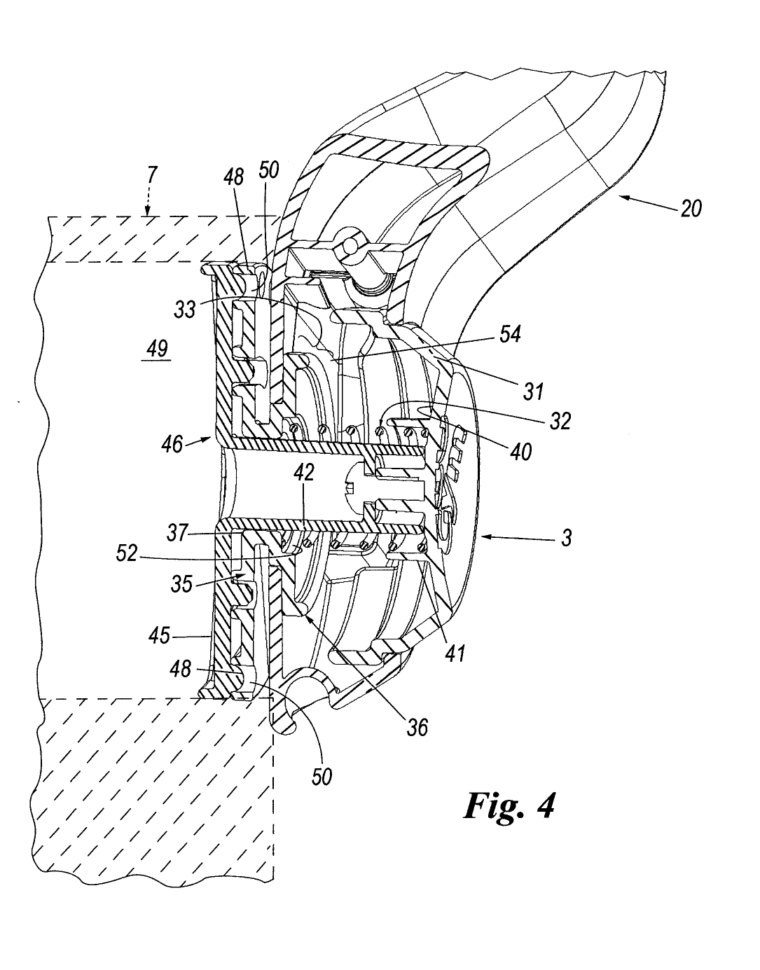

FIG. 4 is a perspective view of an assembled portion of the part of FIG. 3;

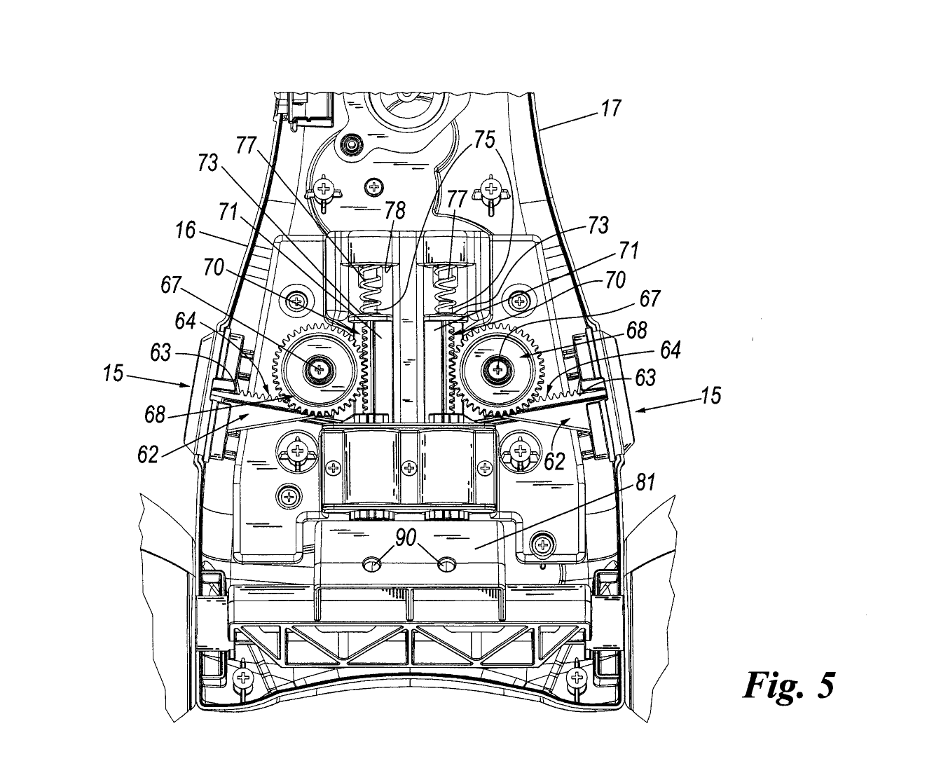

FIG. 5 is a front view of an internal mechanism of the device of FIG. 1;

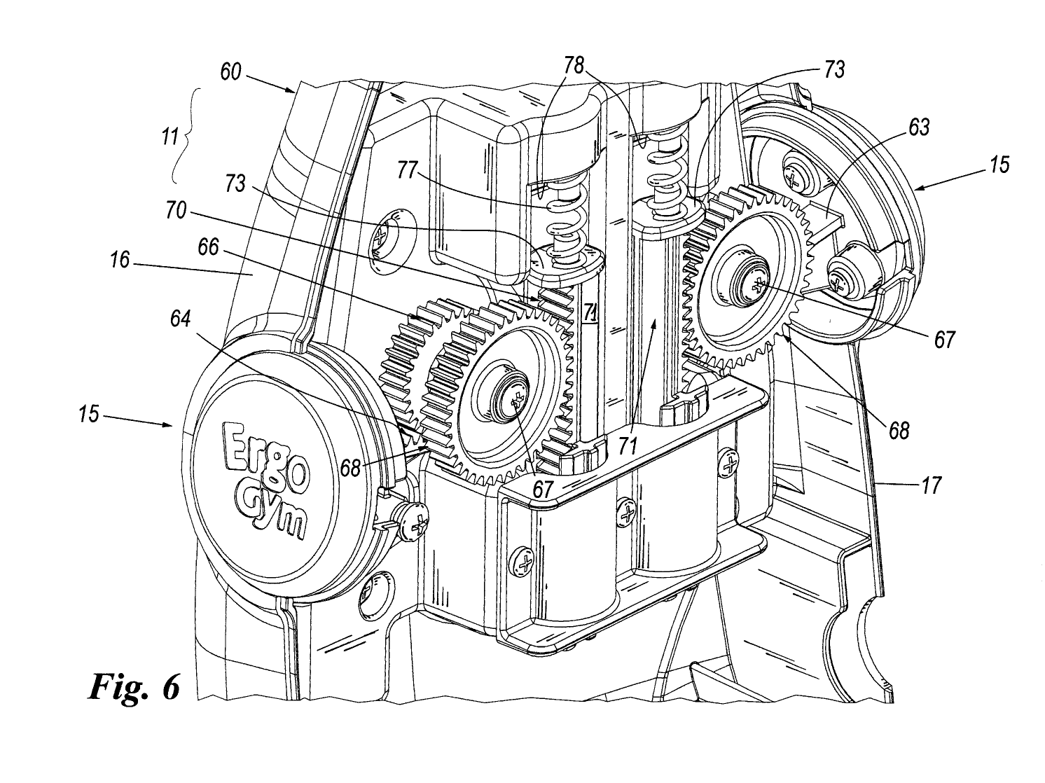

FIG. 6 is a perspective view of the mechanism of FIG. 5;

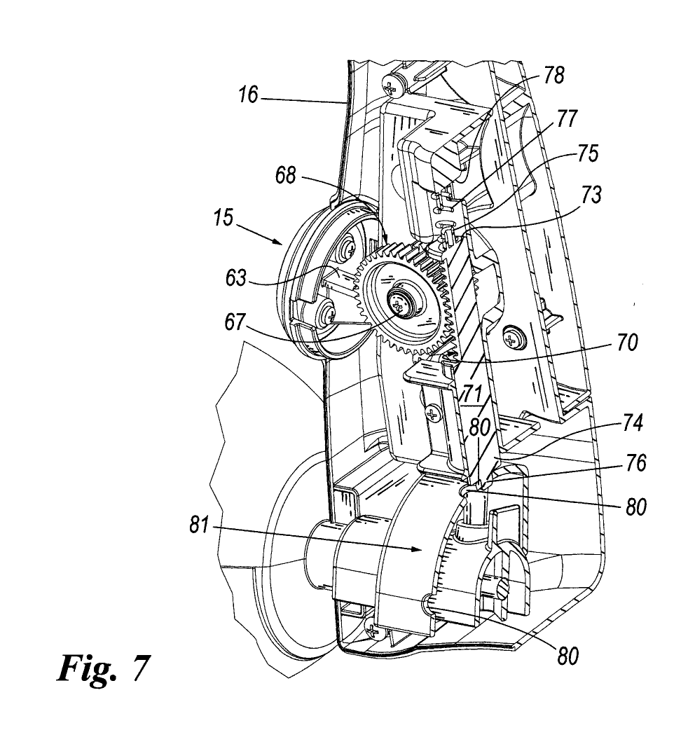

FIG. 7 is a side view of a part of the mechanism of FIG. 5;

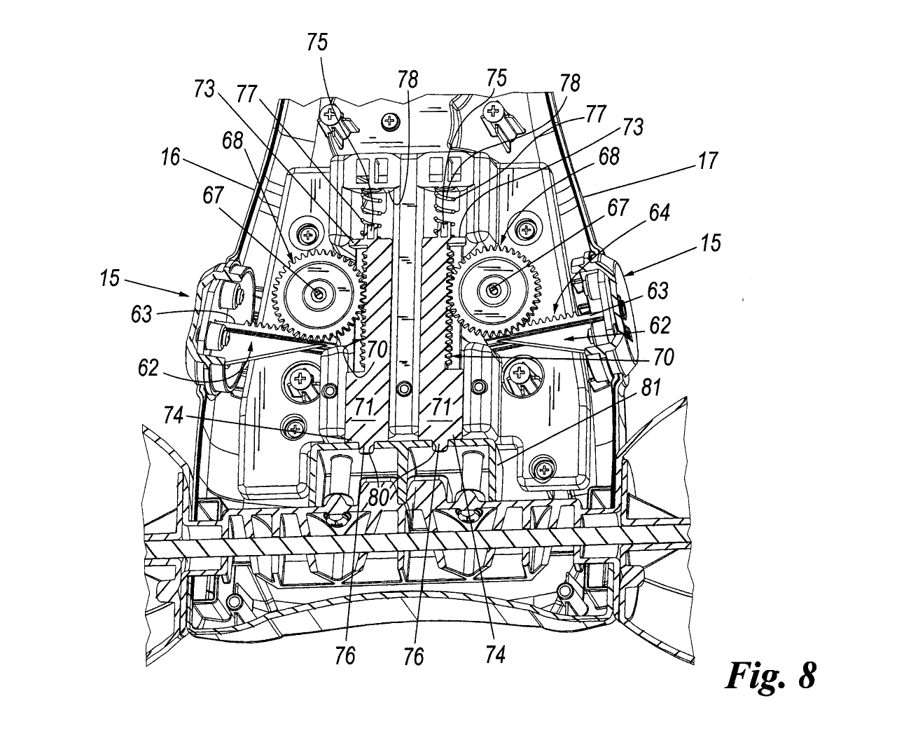

FIG. 8 is a front view, with certain parts removed for greater clarity, of a part of the mechanism of FIG. 5;

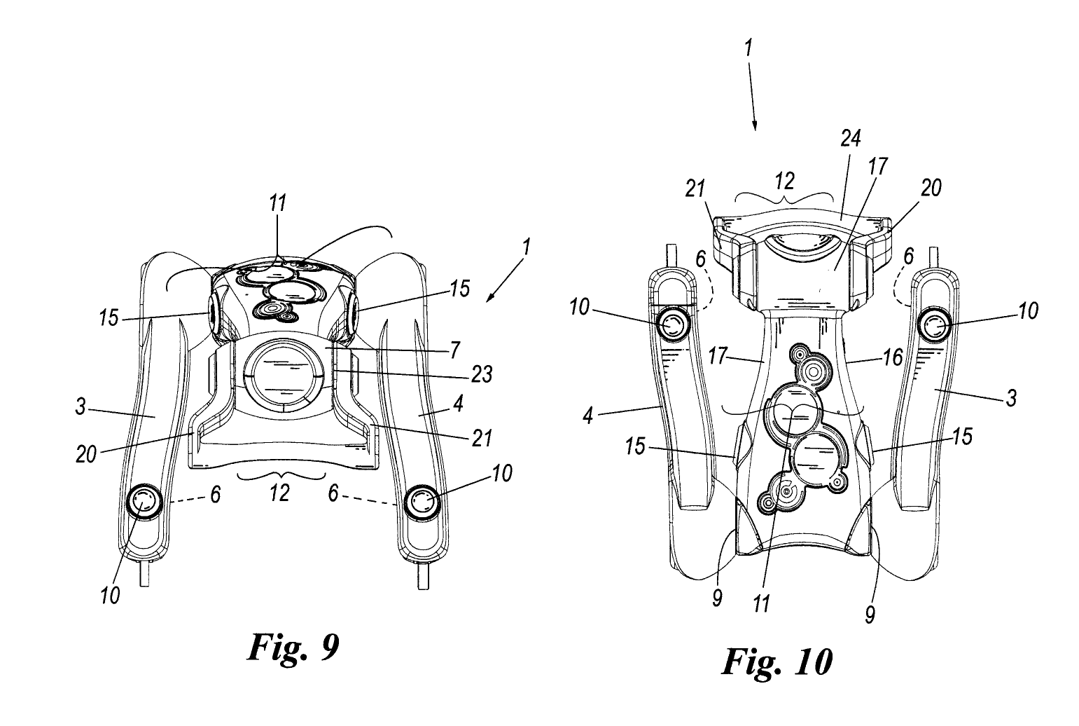

FIG. 9 is a view from above of the device of FIG. 1; and

FIG. 10 is a side view of the device of FIG. 1 in its closed position.

With reference to said figures, a device enabling a child to learn to walk is indicated overall by 1 and comprises a lower portion 2 presenting two arms 3 and 4 each mounted on a front wheel 5 and rear wheel 6, which rest on a surface P.

The rear wheels 6 can be of fixed or pivoting type, in this latter case they comprising a usual pushbutton-type locking element 10 to lock rotation of the corresponding wheel about its axis.

The arms 3 and 4 are hinged (at 9) to the sides of a body 11 provided at its top 7 with a handle 12. The body 11 can be completely folded down between the arms 3 and 4 (FIG. 10) or can assume different stable inclined or angular positions (for example two) relative to these arms. A control member 15, positioned on each side 16 and 17 of the body 11, enables the relative position between the arms 3, 4 and said body to be varied.

The handle 12 comprises lateral arms 20 and 21 hinged (at 23) to the part 7 of the body 11 and supporting a handgrip 24 disposed transversely to said arms and suitably shaped to facilitate its gripping by a child. The handle can stably assume a plurality of positions (for example three) differently inclined to the body 11. The facility to incline the handle 12 and the body 11 into various positions about the arms 3 and 4 (and hence to the surface P) enables the device of the invention to assume different positions, i.e. enables the handle to assume different heights above the surface P such as to follow the various stages in the growth of a child using the device 1, with the child assuming a correct posture while learning to walk, by gripping the handle and moving by walking between the arms 3 and 4.

With reference to FIGS. 3 and 4, these show, for modifying said inclination, a mechanism associated with at least one of the hinges 23 connecting the arms 20 and 21 to the body 11. For simplicity, the figures show said mechanism associated with the arm 20. This mechanism comprises an operating pushbutton 30 for rotating the arms about the body 11; the pushbutton 30 presents a substantially cup-shaped casing 31 cooperating with a compression spring 32 interposed between said casing and a plate-like element 33 presenting two spaced-apart circular portions 35 and 36 connected together by an interconnection part 37. These portions 35, 36 and the part 37 connect the plate-like element 33 both to the arms 20 and 21 while enabling them to move, and to the top 7 of the body 11 with which this element is rigid.

More specifically, projecting inwards from an inner face 40, the casing 31 of the pushbutton 30 presents a cylindrical annular ridge 41 receiving a cylindrical pin 42 passing through an aperture 43 in the corresponding arm 20 or 21 and a corresponding aperture in the top 7 of the body 11. This pin is connected to a transverse portion 45 to form therewith an element 46 for locking the arm 20 or 21 (and hence the entire handle 12, even if the mechanism present is rigid with only one of the arms) in a position inclined to the part 7 of the body 11. The portion 45 presents bosses, needles or similar projections 48 to cooperate, within a cavity 49 of the part 7, with seats 50 provided in the circular portion 35 of the element 33 in spaced-apart positions; the seats 50 define different angular positions of the handle 12 on the body 11.

The compression spring 32 provided between the pin 42 and the ridge 41 rests on the circular portion 36 of the element 33. Preferably, this latter presents a hollow part 52 to receive the spring 32. Inside a cavity 54 of the corresponding arm 20 and 21, the portion 36 rests on the arm itself and on an edge of the part 7 of the body 11. The portion 35 also rests on this edge, but inside the cavity 49 of that part. The transverse portion 45 of the element 46 can move within the cavity 49, away from the portion 36, when the casing 31 of the pushbutton 30 is pressed towards the corresponding arm 20 or 21, to modify the inclination of the handle 12. This pressure against the spring 32 withdraws the portion 45 from the circular portion 35 of the plate-like element 43 such that its bosses 48 leave the seats 50 thereof, enabling the handle to be rotated about the part 7 of the body 11 to hence modify the spatial attitude of the handgrip 24. On releasing the casing 31, the rotation continues until the bosses become positioned in front of other seats 50 (corresponding to a different inclination of the handgrip 24) positioned along a curved line; in this case the spring 32, by acting on the casing, urges these bosses into said seats to lock the rotation of the handle in the attained position.

FIGS. from 5 to 8 show the mechanism for varying the inclination of the body 11 to the wheel-mounted arms 3 and 4.

This mechanism is inserted into a hollow portion 60 of the body 11, on the sides of which at least one control member 15 is present (in the figures this is shown on both the sides 16 and 17 of the body 11). In addition to the control member 15, said mechanism comprises an arm 62 rigid with said member and provided on a side 63 with toothing 64 acting as a rack and cooperating with a gearwheel 66.

This latter is associated, via a usual screw 67, with a second gearwheel 68 which is hence coaxial with the first 66 and torsionally rigid therewith, to cooperate with a rack 70 associated with a member or element 71 movable within the part 60 of the body 11.

The member 71 is of elongate shape (the rack 70 being positioned on a side thereof) with its opposing ends 73 and 74 presenting projecting pins 75, 76 respectively. A spring 77 is mounted about the pin 75 to rest on a fixed part 78 of the body 11 and oppose the movement of the element 71 following rotation of the gearwheel 68, described hereinafter. The pin 76 of the element 71 cooperates with one of a plurality of seats 80 provided in an arch-shaped part 81 rigid with the lower portion 2 of the device 1, and projecting into the part 60 (hollow) of the body 11.

The aforedescribed mechanism for modifying the inclination of the body 11 to the arms 3, 4 and in this manner modifying the spatial attitude (or height) of the handle 12 above the surface P is used in the following manner. To obtain this movement the control member 15 is operated by pressing it towards the interior of the part 60 of the body 11. This pressure causes the corresponding rack 64 to move towards the interior of that part, causing the gearwheel 66 and gearwheel 68 to rotate with consequent movement of the element 71 upwards relative to the arch-shaped part 81. This upward movement takes place against the action of the spring 77. As a result, the pin 76 of the element 71 emerges from the seat 80 in which this pin was located to maintain the previously attained position of the body 11 relative to the arms 3, 4. After the pin 76 leaves the corresponding seat, the body 11 can be directly rotated manually (arrow F of FIG. 1) about the hinges 9 until the pin 76 is positioned above another seat 80. When in this position, by virtue of the thrust of the spring 77 on the element 71 the pin 76 penetrates into said (new) seat 80 to lock rotation of the body 11 about the arms 3 (and return the member 15 into its initial rest position). In this position, the body 11 has assumed a new inclination (different from the preceding) on the surface P.

As shown in FIG. 10, the body 11 can be completely folded towards the arms 3 and 4 to hence attain a position completely folded between them. Again, in this position each pin 76 encounters a corresponding seat (90 in FIG. 5) enabling the body 11 to maintain a stable position between the arms 3 and 4. This enables the device 1 to be easily transported in its folded position.

The invention provides a device enabling a child to learn to walk while maintaining a correct posture during this learning, whatever the height of the child or its age. The device is easy to use and transport.

A preferred embodiment of the invention has been described, however others are possible in the light of the accompanying claims.

1. A device (1) for guiding a child's first steps, comprising a body (11) mounted on wheels (5, 6) and provided with an upper part (7) having a handgrip or handle (12) which the child grips to support itself during its first steps, characterised in that the handle (12) can assume a plurality of stable positions corresponding to different handle heights from a surface (P) on which the wheels (5, 6) rest, hence enabling the child to grip the handle (12) with the correct posture at different stages of its growth.

2. A device as claimed in claim 1, characterised in that said handle (12) is hinged to said upper part (7) of said body (11).

3. A device as claimed in claim 2, characterised in that the handle (12) comprises arms (20, 21) hinged (at 23) to said upper part (7) of the body (11) and supporting a transverse handgrip (24), there being provided, at least at one hinge (23), a mechanism for stably modifying the position of the handgrip relative to said upper part (7) of the body (11), said mechanism comprising a pushbutton (30) movable against an elastic element (32) and connected to means (46) for locking the rotation of the handle (12) about said hinges (23) and arranged to cooperate with a corresponding locking counter-means (33), one from among said means and counter-means (33, 46) being rigid with said handle and the other being rigid with the upper part (7) of the body (11) mounted on wheels (5, 6).

4. A device as claimed in claim 3, characterised in that said means comprise a locking element (46) rigid with the pushbutton and presenting a transverse portion (45) provided with projections (48) cooperating with a plurality of seats (50) provided in a circular portion (35) of a plate-like element (33) acting as a locking counter-means, said seats (50) being positioned along a curved line on said circular portion (35).

5. A device as claimed in claims 3 and 4, characterised in that the plate-like element comprises a second circular portion (36) spaced from the first (35) provided with the seats (50) for the projections (48) on said transverse portion (45), said portions being associated with the upper part (7) of the body (11) mounted on wheels, the first portion being inside a cavity (49) of said part (7) and the second being inserted into a corresponding arm (20, 21) of the handle (12), on the second portion (36) there resting a spring defining the elastic element (32) against which said pushbutton (30) is movable, said spring being secured to a casing (31) of this latter external to the handle (12), the movement of said casing (31) of the pushbutton (30) against the spring causing said locking element (46) to shift within the cavity (49) of said part (7) of the body (11) mounted on wheels (5, 6) and to separate its projections (48) from the seats (50) of said first circular portion (35) of the plate-like element, to hence allow rotation of the handle (12) about the hinges (23) which secure it to said part (7) of the wheel-mounted body (11).

6. A device as claimed in claim 1, characterised in that the handle is profiled.

7. A device as claimed in claim 1, characterised in that the wheel-mounted body (11) is also hinged (at 9) to a device lower portion (2) comprising said wheels (5, 6), said body being able to assume a plurality of positions inclined to said lower portion (2) to hence modify the spatial attitude of the handle (12), i.e. its distance from the resting surface (P).

8. A device as claimed in claim 7, characterised in that a control member is present on at least one side (16, 17) of said body (11) to modify the position of said body relative to said lower portion (2) of the device (1).

9. A device as claimed in claim 8, characterised in that said control member (15) is associated, within a hollow portion (60) of the wheel-mounted body (11), with an arm (62) projecting towards the interior of said wheel-mounted body (11) and presenting a rack (64) cooperating with a gearwheel assembly (66, 68), itself connected to a rack (70) on a member (71) associated with said body and movable against a spring (77), and presenting locking means (76) cooperating with locking counter-means (80, 81) associated with said lower portion (2) of the device (1) in such a manner as to define a plurality of stable inclined positions of the body relative to said portion (2).

10. A device as claimed in claim 9, characterised in that said locking means comprise a pin (76) projecting from an end (74) of said member (71), the locking counter-means comprising seats (80) provided within an arch-shaped part (81) projecting into the hollow portion (60) of said wheel-mounted body.

11. A device as claimed in claim 7, characterised in that the device lower portion (2) comprises two spaced-apart arms (3, 4) supporting the wheels (5, 6), said arms defining a space for the movement of the child acting on the handle (12).

12. A device as claimed in claim 11, characterised in that the body (11) is completely reclinable into the space defined by the arms (3, 4) supporting the wheels (5, 6).

13. A device as claimed in claim 1, characterised in that at least part of the wheels (5, 6) are pivoting but are lockable in a fixed position of use.
